(19) United States
(12) Patent Application Publication
(10) Pub. No.: US 2014/0013130 A1
(43) Pub. Date: Jan. 9, 2014

(54) EXPANSION CIRCUIT FOR SERVER SYSTEM AND SERVER SYSTEM USING SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: BO TIAN, Shenzhen (CN); KANG WU, Shenzhen (CN)

(21) Appl. No.: 13/934,258

(22) Filed: Jul. 3, 2013

(30) Foreign Application Priority Data
Jul. 5, 2012 (CN) 2012102313711

(51) Int. Cl. G06F 1/26

(52) U.S. Cl. CPC G06F 1/266
USPC 713/300

(57) ABSTRACT

An expansion circuit for a server system includes a power input terminal, a first output terminal and a second output terminal. The power input terminal is configured to receive a first voltage. The first output terminal is configured to receive the first voltage from the power input terminal and provide the first voltage to a first hard disk drive group of the server system. The second output terminal is configured to receive the first voltage from the power input terminal and provide the first voltage to a second hard disk drive group of the server system when the first hard disk drive group and the second hard disk drive group are controlled by a same server.

### CROSS-REFERENCE TO RELATED APPLICATIONS

This application is related to an US patent application with an attorney docket No. US45601 and entitled “EXPANSION CIRCUIT FOR SERVER SYSTEM AND SERVER SYSTEM USING SAME”, and also claims a foreign priority application filed in China as Serial No. 201210231371.1 on Jul. 5, 2012. These related applications are incorporated herein by reference.

### BACKGROUND

1. Technical Field

The present disclosure relates to an expansion circuit for a server system and a server system using the same.

2. Description of Related Art

In a server system, servers are usually placed in an enclosure and configured to control hard disk drives. Generally, one server controls a corresponding hard disk drive group. However, when a number of the severs is less than a number of the hard disk drive groups, one or more hard disk drive groups cannot be used, causing a waste of resources.

What is needed is to provide a means that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of a sever system according to a first embodiment of present disclosure.

FIG. 2 is a circuit diagram of the sever system of FIG. 1.

FIG. 3 is an isometric view of a connector of an adapter board of FIG. 2.

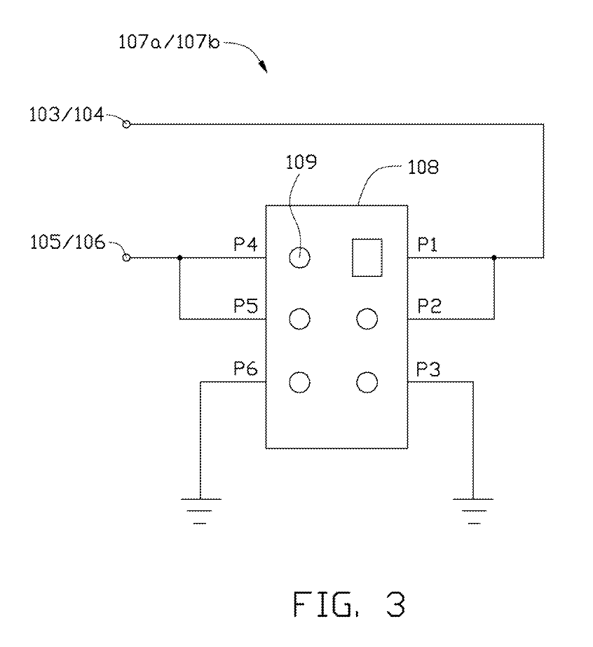

FIG. 4 is a circuit diagram of a sever system according to a second embodiment of present disclosure in a first using state.

FIG. 5 is a circuit diagram of the sever system of FIG. 4 in a second using state.

### DETAILED DESCRIPTION

Reference will now be made to the drawings to describe certain exemplary embodiments of the present disclosure in detail.

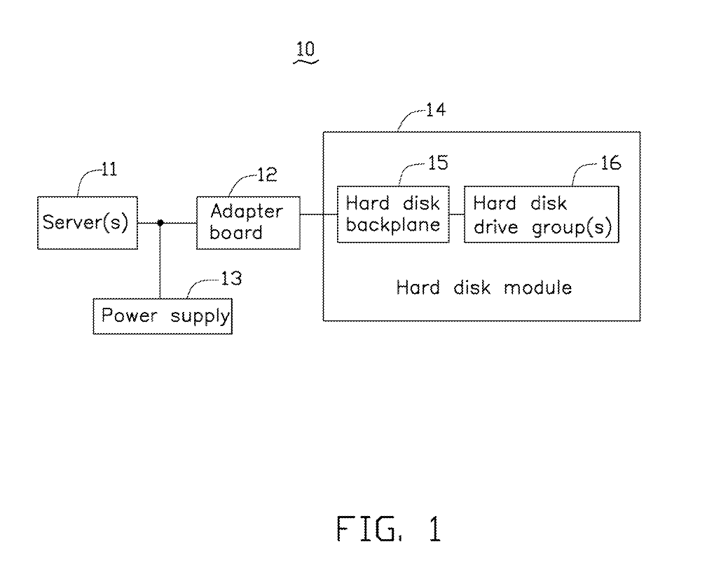

Referring to FIG. 1, a server system 10 includes at least one server 11, at least one adapter board 12, a power supply 13, and a hard disk module 14. The hard disk module 14 includes a hard disk backplane 15 and at least one hard disk drive group 16. The server 11, the at least one adapter board 12, the power supply 13, and the hard disk module 14 are placed in an enclosure of the server system 10. The at least one server 11 is electronically coupled to the hard disk drive group 16 via the at least one adapter board 12 and the hard disk backplane 14 sequentially to control the at least one hard disk drive group 16. The power supply 13 is electronically coupled to the at least one server 11 and the at least one adapter board 12 to supply power to the at least one server 11 and the at least one adapter board 12.

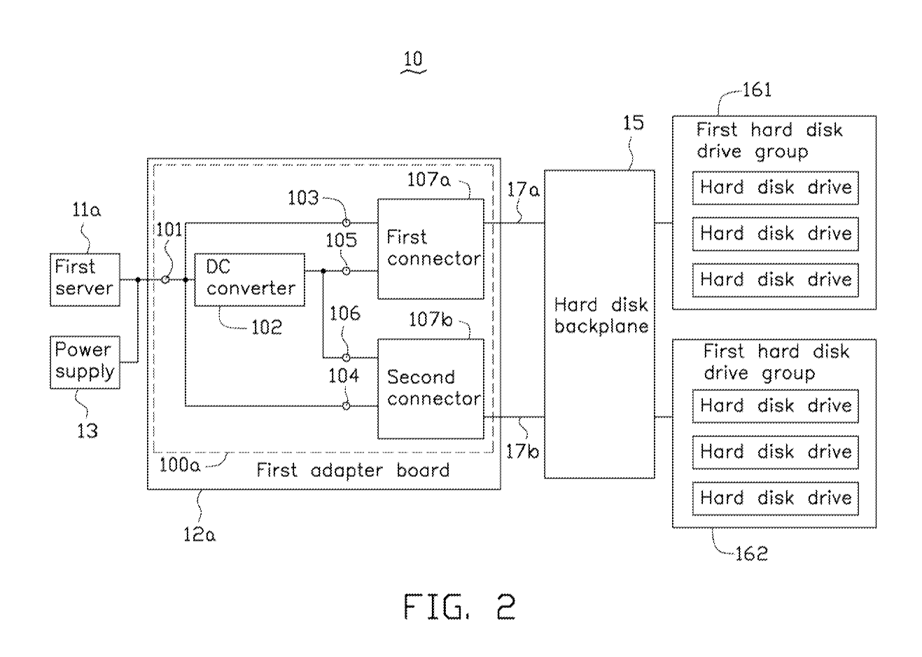

Referring to FIG. 2, the at least one sever 11 may include a first server 11a, the at least one adapter board 12 may include a first adapter board 12a and a second adapter board 12b, and the at least one hard disk drive group 16 may include a first hard disk drive group 161 and a second hard disk drive group 162. The first adapter board 12a includes an expansion circuit 100 to supply power to the first hard disk drive group 161 and the second hard disk drive group 162 via the hard disk backplane 15.

The expansion circuit 100 includes a power input terminal 101, a direct current (DC) converter 102, a first output terminal 103, a second output terminal 104, a third output terminal 105, a fourth output terminal 106, a first connector 107a, and a second connector 107b. The power input terminal 101 is electrically coupled to the power supply 13 to receive a first voltage. The first output terminal 103 is electrically coupled to the power input terminal 101 to receive the first voltage and provides the first voltage to the first hard disk drive group 161 via the first connector 107a and the hard disk backplane 15. The second output terminal 104 is electrically coupled to the power input terminal 101 to receive the first voltage and provides the first voltage to the second hard disk drive group 162 via the second connector 107b and the hard disk backplane 15. The DC converter 102 converts the first voltage of the power input terminal 101 into a second voltage and provides the second voltage to the third output terminal 105 and the fourth output terminal 106. The third output terminal 105 provides the second voltage to the first hard disk drive group 161 via the first connector 107a and the hard disk backplane 15, and the fourth output terminal 106 provides the second voltage to the second hard disk drive group 162 via the second connector 107b and the hard disk backplane 15. The first voltage is 5 volts, and the second voltage is 12 volts, in one example.

Referring to FIG. 2, each of the first connector 107a and the second connector 107b includes a first pin P1, a second pin P2, a third pin P3, a fourth pin P4, a fifth pin P5, a sixth pin P6, a shell 108 and a output terminal 109. The first and the second pins P1 and P2 of the first connector 107a are connected to the first output terminal 103, the third and the sixth pins P3 and P6 of the first connector 107a are grounded, the fourth and the fifth pins P4 and P5 of the first connector 107a are connected to the third output terminal 105, and the output terminal 109 of the first connector 107a is electrically connected to the first hard disk drive group 161 via a hard disk backplane 15 and a cable 17a.

The first and the second pins P1 and P2 of the second connector 107b are connected to the first output terminal 103, the third and the sixth pins P3 and P6 of the second connector 107b are grounded, the fourth and the fifth pins P4 and P5 of the second connector 107b are connected to the third output terminal 105, and the output terminal 109 of the second connector 107b is electrically connected to the first hard disk drive group 161 via a hard disk backplane 15 and a cable 17b.

In summary, it can be seen that, when the server system 10 just has a first sever 11 but has two hard disk drive groups 161 and 162, the two hard disk drive groups 161 and 162 can electrically coupled to the first connector 107a and the second connector 107b via the hard disk backplane 15 respectively, such that the first sever 11 can control the two hard disk drive groups 161 and 162, and the problem of resource waste can be improved.

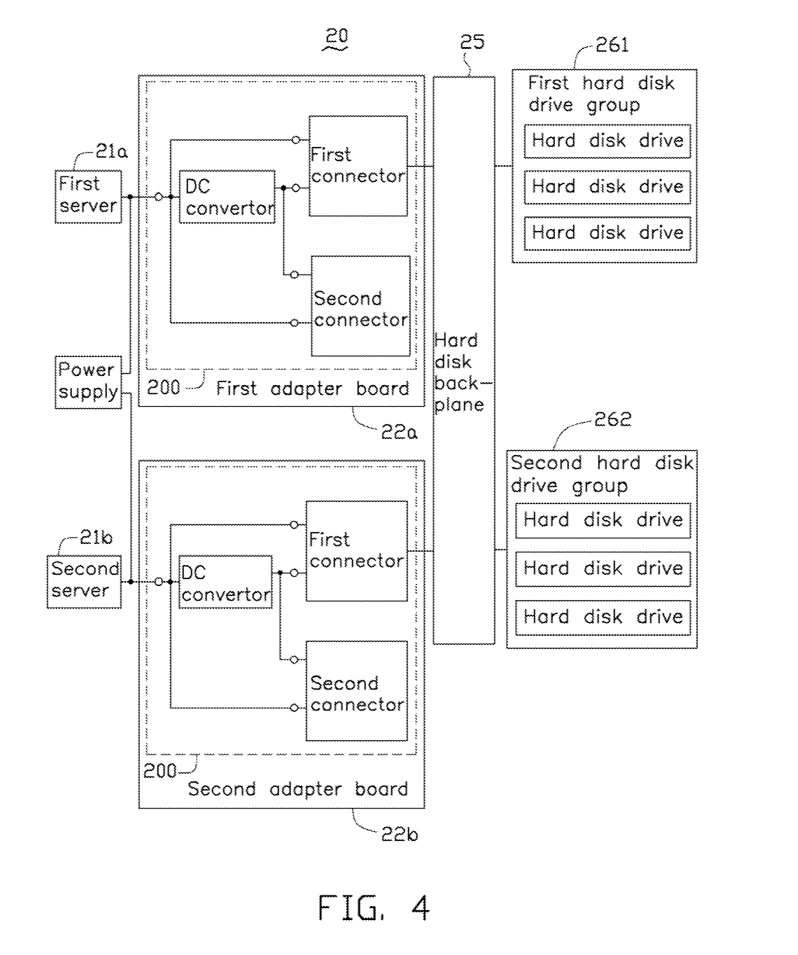

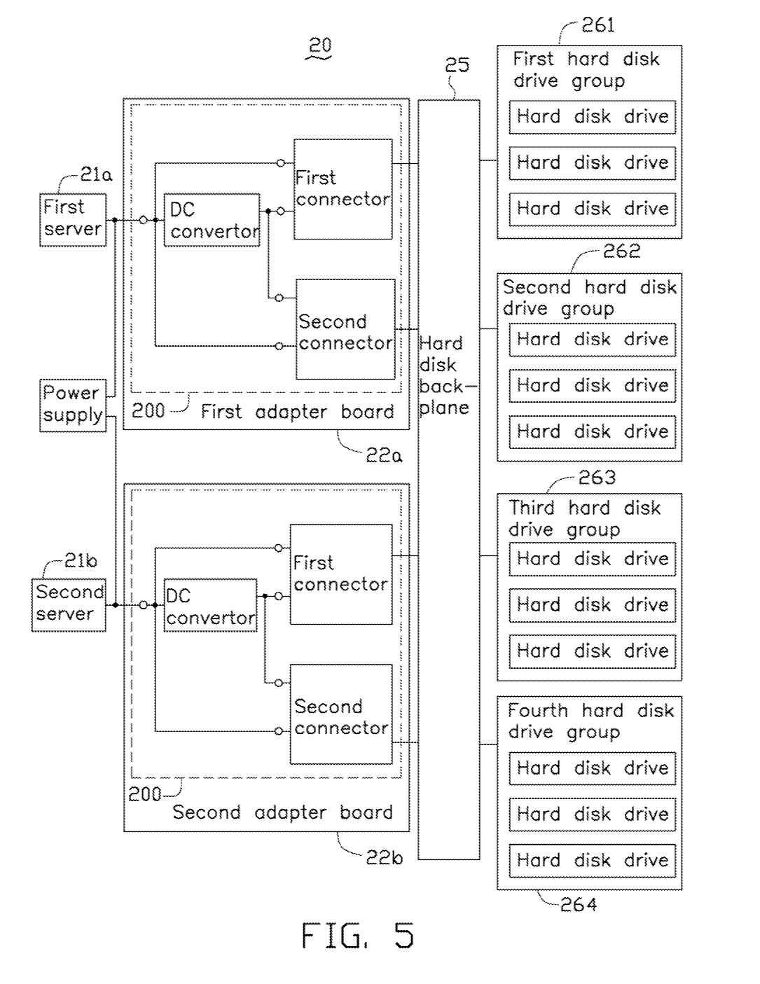

Referring to FIG. 4 and FIG. 5, a sever system 20 according to a second embodiment is shown. When the sever system 20 is in a first using state, the sever system 20 includes a first server 21a, a second sever 21b, a first adapter board 22a, a second adapter board 22b, a hard disk backplane 25, a first hard disk drive group 261 and a second hard disk drive group 262. Each of the first adapter board 22a and the second adapter board 22b includes an expansion circuit 200. The expansion circuit 200 has the same structure as the expansion circuit 100 in FIG. 2. Details of the structure of the expansion circuit 200 are not described here. In the first using state, the first sever 21a is electrically coupled to the first hard disk drive group 261 via the expansion circuit 200 of the first adapter board 22a and the hard disk backplane 25.

When the sever system 20 is in a second using state, the sever system 20 includes the first server 21a, the second sever 21b, the first adapter board 22a, the second adapter board 22b, the hard disk backplane 25, the first hard disk drive group 261, the second hard disk drive group 262, a third hard disk drive group 263 and a fourth hard disk drive group 264. In the second using state, the first sever 21a is electrically coupled to the first hard disk drive group 261 and the second hard disk drive group 262 via the expansion circuit 200 of the first adapter board 22a and the hard disk backplane 25, and the second sever 21b is electrically coupled to the third hard disk drive group 261 and the fourth hard disk drive group 262 via the expansion circuit 200 of the second adapter board 22b and the hard disk backplane 25.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of shape, size and arrangement of parts within the principles of the present disclosure to the full extent indicated by the broad general meaning of the terms in which the appended claims are expressed.

What is claimed is:

1. An expansion circuit for a server system, comprising:
a power input terminal configured to receive a first voltage;
a first output terminal configured to receive the first voltage from the power input terminal and provide the first voltage to a first hard disk drive group of the server system; and
a second output terminal configured to receive the first voltage from the power input terminal and provide the first voltage to a second hard disk drive group of the server system when the first hard disk drive group and the second hard disk drive group are controlled by a same server.

2. The expansion circuit of claim 1, further comprising a first connector and a second connector, the first output terminal providing the first voltage to the first hard disk drive group via the first connector, the first connector comprising a pin and an output terminal connected the pin, the pin of the first connector connected to the first output terminal, the output terminal of the first connector providing the first voltage to the first hard disk drive group, the second output terminal providing the first voltage to the second hard disk drive group via the second connector, the second connector comprising a pin and an output terminal connected the pin, the pin of the second connector connected to the second output terminal, the output terminal of the second connector providing the first voltage to the second hard disk drive group.

3. The expansion circuit of claim 2, further comprising a third output terminal and a fourth output terminal, the third output terminal configured to receive a second voltage and provide the second voltage to the first hard disk drive group via the first connector, the forth output terminal configured to receive the second voltage and provide the second voltage to the second hard disk drive group via the second connector.

4. The expansion circuit of claim 3, further comprising a DC converter, an input terminal of the DC converter connected to the power input terminal, an output terminal of the DC converter connected to the third output terminal and the fourth output terminal, the DC converter configured to convert the first voltage from the power input terminal into the second voltage and provide the second voltage to the third and the fourth output terminal.

5. The expansion circuit of claim 4, wherein the first connector further comprises five pins, the six pins of the first connector is defined as a first pin, a second pin, a third pin, a fourth pin, a fifth pin, and a sixth pin, the first and the second pins of the first connector are connected to the first output terminal, the third and the sixth pins of the first connector are grounded, the fourth and the fifth pins of the first connector are connected to the third output terminal, and the output terminal of the first connector is electrically connected to the first hard disk drive group via a hard disk backplane.

6. The expansion circuit of claim 5, wherein the second connector further comprises five pins, the six pins of the second connector is defined as a first pin, a second pin, a third pin, a fourth pin, a fifth pin, and a sixth pin, the first and the second pins of the second connector are connected to the second output terminal, the third and the sixth pins of the second connector are grounded, the fourth and the fifth pins of the second connector are connected to the fourth output terminal, and the output terminal of the second connector is electrically connected to the second hard disk drive group via the hard disk backplane.

7. The expansion circuit of claim 6, wherein the expansion circuit is located at an adapter board connected between a server and the hard disk backplane.

8. A server system, comprising:
a first hard disk drive group;
a second hard disk drive group;
at least one server configured to control the first and the second hard disk drive groups;
a power supply; and
a first expansion circuit comprising:
a power input terminal configured to receive a first voltage from the power supply;
a first output terminal configured to receive the first voltage from the power input terminal and provide the first voltage to the first hard disk drive group; and
a second output terminal configured to receive the first voltage from the power input terminal and provide the first voltage to the second hard disk drive group when the first hard disk drive group and the second hard disk drive group are controlled by the same server.

9. The server system of claim 8, wherein the first expansion circuit further comprises a first connector and a second connector, the first output terminal providing the first voltage to the first hard disk drive group via the first connector, the first connector comprising a pin and an output terminal connected the pin, the pin of the first connector connected to the first output terminal, the output terminal of the first connector providing the first voltage to the first hard disk drive group, the second output terminal providing the first voltage to the second hard disk drive group via the second connector, the second connector comprising a pin and an output terminal connected the pin, the pin of the second connector connected to the second output terminal, the output terminal of the second connector providing the first voltage to the second hard disk drive group.

10. The server system of claim 9, wherein the first expansion circuit further comprises a third output terminal and a fourth output terminal, the third output terminal configured to receive a second voltage and provide the second voltage to the first hard disk drive group via the first connector, the forth output terminal configured to receive the second voltage and provide the second voltage to the second hard disk drive group via the second connector.

11. The server system of claim 10, wherein the first expansion circuit further comprises a DC converter, an input terminal of the DC converter connected to the power input terminal, an output terminal of the DC converter connected to the third output terminal and the fourth output terminal, the DC converter configured to convert the first voltage from the power input terminal into the second voltage and provide the second voltage to the third and the fourth output terminal.

12. The server system of claim 11, wherein the first connector further comprises five pins, the six pins of the first connector is defined as a first pin, a second pin, a third pin, a fourth pin, a fifth pin, and a sixth pin, the first and the second pins of the first connector are connected to the first output terminal, the third and the sixth pins of the first connector are grounded, the fourth and the fifth pins of the first connector are connected to the third output terminal, and the output terminal of the first connector is electrically connected to the first hard disk drive group via a hard disk backplane.

13. The server system of claim 12, wherein the second connector further comprises five pins, the six pins of the second connector is defined as a first pin, a second pin, a third pin, a fourth pin, a fifth pin, and a sixth pin, the first and the second pins of the second connector are connected to the second output terminal, the third and the sixth pins of the second connector are grounded, the fourth and the fifth pins of the second connector are connected to the fourth output terminal, and the output terminal of the second connector is electrically connected to the second hard disk drive group via the hard disk backplane.

14. The server system of claim 13, wherein the first expansion circuit is located at a first adapter board connected between the at least one server and the hard disk backplane.

15. The server system of claim 8, further comprising a second expansion circuit configured to control the second hard disk drive group when the first and the second hard disk drive groups are controlled by two severs of the at least one server respectively.

16. The server system of claim 15, further comprising a third hard disk drive group and a fourth hard disk drive group, wherein the second expansion circuit comprising:
a power input terminal configured to receive the first voltage from the power supply;
a first output terminal configured to receive the first voltage from the power input terminal and provide the first voltage to the third hard disk drive group; and
a second output terminal configured to receive the first voltage from the power input terminal and provide the first voltage to the fourth hard disk drive group when the third hard disk drive group and the fourth hard disk drive group are controlled by the same server.

17. The server system of claim 16, further comprising a first adapter board and a second adapter board independent from the first adapter board, the first expansion circuit is located on the first adapter board, and the second expansion circuit is located on the second adapter board.
